(19) United States
(12) Patent Application Publication
(10) Pub. No.: US 2020/0207502 A1
(43) Pub. Date: Jul. 2, 2020

(54) COUPLING ELEMENT OF TRACKING TAGS AND SEMI-FINISHED METALLURGICAL PRODUCTS AND RESPECTIVE APPLICATION SYSTEM OF COUPLING ELEMENTS TO SEMI-FINISHED METALLURGICAL PRODUCTS

(71) Applicant: BM GROUP HOLDING S.p.A., Borgo Chiese (TN) (IT)

(72) Inventors: Mirko Bottini, Borgo Chiese (TN) (IT); Andrea Tonini, Storo (TN) (IT); Andrea Faes, Vezzano (TN) (IT); Ruggero Forelli, Borgo Chiese (TN) (IT)

(21) Appl. No.: 16/725,263

(22) Filed: Dec. 23, 2019

(30) Foreign Application Priority Data
Dec. 28, 2018 (IT) 102018000021364

(51) Int. Cl. B65C 1/02; B27F 7/09

(52) U.S. Cl. CPC B65C 1/02; B27F 7/09

(57) ABSTRACT

The present invention relates to a coupling element of tracking tags and semi-finished metallurgical products. The coupling element comprises: at least a fixing portion adapted to permanently engage a respective semi-finished metallurgical product; at least a receiving portion engaged to the fixing portion and for receiving with engagement at least one tracking tag; at least a retaining portion engaged with the receiving portion of the tracking tag on the opposite side with respect to the fixing portion to keep the respective tracking tag trapped between the target semi-finished metallurgical product and the retaining portion when the coupling element is engaged with a semi-finished metallurgical product. The fixing portion has at least one tapering defining a pointed end arranged to penetrate a respective semi-finished metallurgical product. A system for applying coupling elements is provided which provides for the use of an application device with striker.

### BACKGROUND OF THE INVENTION

The present invention relates to a coupling element of tracking tags to semi-finished metallurgical products, such as billets, slabs, blooms, drums, wire rods, metal beams and/or the like.

The present invention also relates to a system for applying the aforementioned coupling elements to the aforementioned semi-finished metallurgical products.

It is known to track the semi-finished metallurgical products by applying respective metal tags on which one or more information and/or data relating to the product in question and/or to the relative production process are reported in a coded manner.

Usually, each tracking tag is provided with a through hole designed to receive with engagement a respective metallic coupling element, such as for example a nail, a thread-like element or a staple, which is fixed on the corresponding semi-finished metallurgical product by means of a suitable welding operation, generally by electric arc.

Although the application of tracking tags to semi-finished metallurgical products by electric arc welding of the coupling elements is particularly widespread, the Applicant has found that it is not however free from some drawbacks and can be improved in several respects, mainly in relation to the quality of the welding carried out, as well as the duration thereof.

In particular, the Applicant has found that the quality of the electric arc welding depends on the type of materials that make up the target semi-finished metallurgical products.

The Applicant's research has highlighted that in the presence of semi-finished metallurgical products having significant amounts of boron, the welding surfaces are subject to an excessive formation of alumina oxide which, since it has a poor electrical conductivity, acts as an electrically insulating layer which greatly limits the quality of the welding between the coupling elements and the target products.

Consequently, the welding carried out on this type of semi-finished metallurgical products does not guarantee the minimum required seal to the coupling elements during the handling phases of the semi-finished product inside the production site or transported to the final customer, so that the coupling elements tend to detach easily together with the respective tracking tags.

### BRIEF SUMMARY OF THE INVENTION

The main object of the present invention is to propose a coupling element between tracking tags and semi-finished metallurgical products, such as billets, slabs, blooms, drums, wire rods, metal beams and/or the like, as well as a system for applying these coupling elements to the aforesaid products, which is able to solve the problems encountered in the known technique.

An object of the present invention is that of ensuring the engagement of the coupling elements to any type of semi-finished metallurgical product, including those which due to the materials which make them up do not allow an optimal electric arc welding.

A further object of the present invention is that of providing an engagement between the coupling elements and the semi-finished metallurgical products which is stable.

It is also an object of the present invention to ensure an engagement between the coupling elements and the metallurgical products which is durable.

The objects specified above and others are substantially achieved by a coupling element for coupling tracking tags to semi-finished metallurgical products, such as billets, slabs, blooms, drums, wire rods, metal beams and/or the like and a system for applying these coupling elements to the aforesaid semi-finished metallurgical products, in accordance with what is described and claimed below.

The description of a preferred but not exclusive embodiment of a coupling element for coupling tracking tags to semi-finished metallurgical products, such as billets, slabs, blooms, drums, wire rods, metal beams and/or the like as well as a system for applying this coupling element to a target semi-finished metallurgical product in accordance with the present invention is now reported.

### BRIEF DESCRIPTION OF THE DRAWINGS

Such description will be made herein below with reference to the accompanying drawings, provided for indicative only and therefore not limiting purpose, in which:

FIG. 1 is a perspective view of a coupling element for coupling tracking tags to semi-finished metallurgical products, such as billets, slabs, blooms, drums, wire rods, metal beams and/or the like in accordance with the present invention;

FIG. 2 is a side elevation view of the coupling element of FIG. 2;

FIG. 3 is a front elevation view of the coupling element of FIGS. 1 and 2;

FIG. 4 is a perspective view of a device for applying coupling elements of tracking tags to semi-finished metallurgical products.

### DETAILED DESCRIPTION OF THE PREFERRED EMBODIMENTS

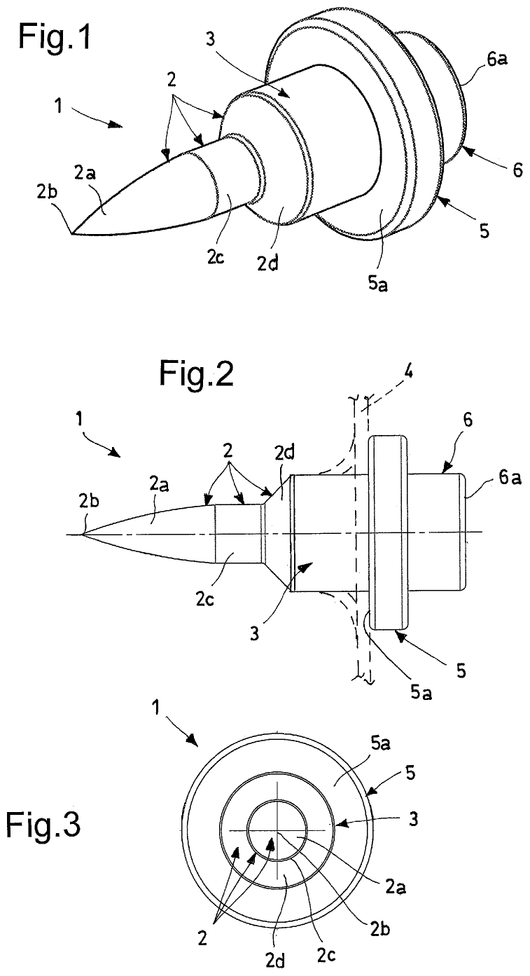

With reference to FIGS. 1 to 3, the reference numeral 1 generally indicates a coupling element for coupling tracking tags to semi-finished metallurgical products, such as billets, slabs, blooms, drums, wire rods, metal beams and/or the like in accordance with the present invention.

As can be seen in FIGS. 1 to 3, the coupling element 1 comprises at least a fixing portion 2 adapted to permanently engage a respective semi-finished metallurgical product (not shown as it is known) and at least a receiving portion 3 engaged with the fixing portion 2 for receiving with engagement at least one tracking tag 4 (indicated in broken line in FIG. 2).

The coupling element 1 further comprises at least a retaining portion 5 engaged with the receiving portion 3 on the opposite side with respect to the fixing portion 2, the retaining portion 5 projecting transversely with respect to the longitudinal development of the fixing 2 and receiving 3 portions to keep the respective tracking tag 4 trapped between the target semi-finished metallurgical product and the retaining portion 5 when the coupling element 1 is engaged with a semi-finished metallurgical product.

More in detail, the fixing portion 2 has at least one tapering 2a defining a pointed end 2b arranged to penetrate a respective semi-finished metallurgical product.

As can be seen in FIGS. 1 and 2, the tapering 2a of the fixing portion 2 of the coupling element 1 has a substantially ogival shape which promotes and facilitates the penetration of the coupling element 1 into the respective semi-finished metallurgical product.

Advantageously, the tapering 2a with an ogival shape of the fixing portion 2 of the coupling element 1 ensures a distribution of the impact force which is generated over the whole section of the coupling element 1 during the penetration of the semi-finished metallurgical product.

Still with reference to FIGS. 1 and 2, the fixing portion 2 of the coupling element 1 has at least a constant cross-section length, preferably having a substantially circular cross-section, interposed between the tapering 2a and the receiving portion 3 of the tracking tag 4.

In addition, the fixing portion 2 of the coupling element 1 also comprises at least one connection 2d to the receiving portion 3 of the tracking tag 4. The connection 2d conforms the cross-section of the constant cross-section length 2c of the fixing portion 2 to the section of the receiving portion 3 of the tracking tag 4.

Still referring to FIGS. 1 to 3, the receiving portion 3 of the tracking tag 4 has a section larger than the fixing portion 2, detectable both at the tapering 2a and at the section of the constant cross-section length 2c.

As can be seen in FIGS. 1 and 2, the connection 2d of the fixing portion 2 to the receiving portion 3 of the tracking tag 4 has a substantially frusto-conical shape.

In other words, the section of the connection 2d of the fixing portion 2 increases, preferably in a constant manner, towards the receiving portion 3 of the tracking tag 4.

As can be seen in FIGS. 1 to 3, the retaining portion 5 has at least one abutment surface 5a, preferably facing towards the fixing portion 2, for supporting the tracking tag 4 engaged with the receiving portion 3.

On the opposite side with respect to the fixing 2 and receiving 3 portions of the tracking tag 4, the coupling element 1 is also provided with at least one contact portion 6 which engages the retaining portion 5.

The contact portion 6 has an abutment surface 6a facing the opposite side with respect to the fixing portion 2 and the abutment surface 5a of the retaining portion 5 of the tracking tag 4 for the engagement of a striker 100 of an application device 101 of the coupling elements 1 which will be described below.

Preferably, the coupling element 1 is made in a single piece so that the fixing 2, receiving 3, retaining 5 and contact 6 portions thereof are joined together in one piece allowing to keep in position a tracking tag 4 interposed between the retaining portion 5 and the metallic semi-finished product.

In accordance with an advantageous aspect of the present invention, the coupling element 1 is comprised of steel, preferably carbon steel, even more preferably carbon steel subjected to hardening heat treatment to withstand the strong impact imparted to ensure penetration into the metallic semi-finished product.

In addition, the coupling element 1 has a hardness, expressed in Rockwell scale, between 50 HRC and 58 HRC, preferably between 52 HRC and 56 HRC, even more preferably between 53 HRC and 55 HRC.

In order to give the coupling element 1 a surface protection against oxidation, the coupling element is also subjected to a protective treatment against oxidation, optionally a burnishing surface treatment.

The present invention also relates to a system for applying the coupling elements 1 of the tracking tags 4 to the aforementioned products.

In detail, the application system comprises at least one application device 101 and at least one coupling element 1 like the one previously described.

The application device 101 is arranged to force the coupling element 1 which must be applied to penetrate the respective target semi-finished metallurgical product according to a measure sufficient to ensure the maintenance of the penetration position and avoid the detachment thereof.

In detail, the application device 101 is configured to transmit to the coupling element 1 a thrust force sufficient to cause the insertion, preferably complete, of the tapering 2a of the fixing portion 2 into the target semi-finished metallurgical product thereof.

Preferably the thrust force produced by the application device 101 is sufficient to cause the insertion, preferably complete, also of the section of constant cross-section length 2c of the fixing portion 2 of the coupling element 1 to be applied.

Advantageously, the application device 101 is able to produce a thrust force which allows the coupling element 1 to penetrate the body of the semi-finished metallurgical product up to the connection 2d of the fixing portion 2.

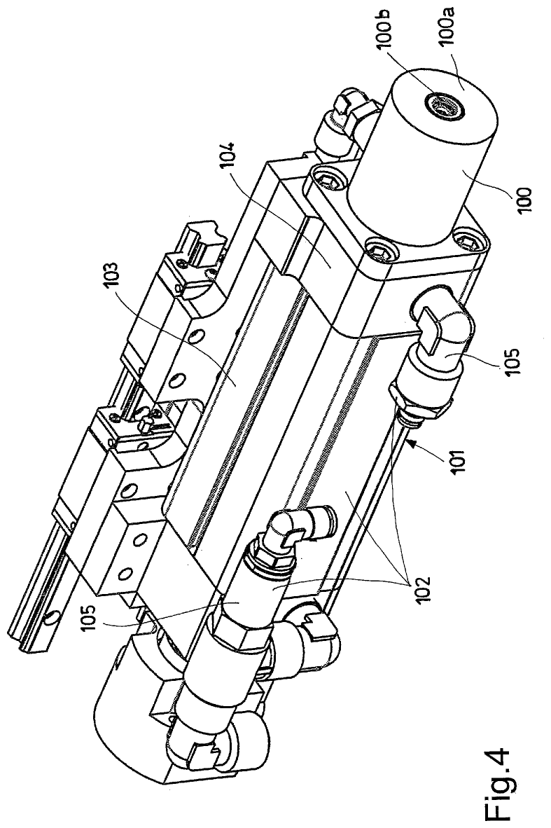

Going into more detail, with the aid of FIG. 4, the application device 101 comprises at least a striker 100 arranged to transmit to the coupling element 1 to be applied the aforementioned thrust force towards the target metallurgical product.

As can be seen in FIG. 4, the striker 100 has a support surface 100a which is placed in contact with the target semi-finished metallurgical product during the application phase of the coupling element 1 on whose support surface 100a an ejection seat 100b for the coupling element 1 to be applied is obtained.

Advantageously, the ejection seat 100b of the striker 100 is provided with at least one suction hole, preferably a plurality of suction holes, through which a depression keeping the coupling element 1 in the ejection seat up to the activation by striker 101 is created, that is up to the application of the coupling element 1 in the respective semi-finished metallurgical product.

The application device 101 further comprises at least an activation mechanism 102 of the striker 100 switchable between a first condition, in which the coupling element 1 is housed in an ejection seat 100b and a second condition in which it actuates the striker 101 to transmit a thrust force to the coupling element 1.

In accordance with a preferred solution of the present invention, the activation mechanism 102 of the application device 101 comprises a fluid-dynamic cylinder 103, preferably a pneumatic cylinder, having one end 104 engaged by the striker 100.

The activation mechanism 102 of the application device 101 further comprises a collision plunger (not visible in the appended figures) operatively engaged within the cylinder 102. The collision plunger is movable along the cylinder 103 to impact against the striker 100 when the activation mechanism 102 is switched from the first to the second condition. The impact between the collision plunger and the striker 100 causes the coupling element 1 placed in the ejection seat 100b thrusting towards the target semi-finished metallurgical product.

In order to control the movement of the collision plunger of the activation mechanism 102, the latter is also provided with at least a fluid-dynamic duct 105, preferably two or more fluid-dynamic ducts connected to the cylinder 103 and to a respective fluid-dynamic control circuit.

The coupling element and the application system of the coupling elements described above solve the problems encountered in the known art and achieve important advantages.

First of all, the particular conformation of the coupling element allows and ensures a firm and stable penetration of any semi-finished metallurgical product.

The ogival fixing portion facilitates and greatly promotes the penetration of semi-finished metallurgical products.

Furthermore, the section differences of the coupling element ensure an effective mechanical seal of the same in the destination semi-finished metallurgical products.

1. Coupling element of tracking tags and semi-finished metallurgical products, such as billets, slabs, blooms, drums, wire rods, metal beams and/or like, the coupling element comprising:
at least a fixing portion adapted to permanently engage a respective semi-finished metallurgical product;
at least a receiving portion for receiving with engagement at least one tracking tag, the receiving portion being engaged to the fixing portion;
at least a retaining portion engaged with the receiving portion of the tracking tag on the opposite side with respect to the fixing portion, the retaining portion projecting transversely with respect to the longitudinal development of the fixing and receiving portions of the tracking tag to keep the respective tracking tag trapped between the target semi-finished metallurgical product and the retaining portion when the coupling element is engaged with a semi-finished metallurgical product,
characterized in that the fixing portion has at least one tapering defining a pointed end arranged to penetrate a respective semi-finished metallurgical product.

2. Coupling element according to claim 1, wherein the tapering has a substantially ogival shape.

3. Coupling element according to claim 1, wherein the fixing portion has at least a constant cross-section length, preferably having a substantially circular cross-section, interposed between the tapering and the receiving portion of the tracking tag.

4. Coupling element according to claim 1, wherein the fixing portion further comprises at least one connection to the receiving portion of the tracking tag, the connection conforming the cross-section of the constant cross-section length to the section of the receiving portion of the tracking tag.

5. Coupling element according to claim 1, wherein the receiving portion of the tracking tag has a section larger than the fixing portion.

6. Coupling element according to claim 5 wherein the connection of the fixing portion to the receiving portion of the tracking tag has a substantially frusto-conical shape, whose section increases towards the receiving portion of the tracking tag.

7. Coupling element according to claim 1, wherein the retaining portion has at least one abutment surface, preferably facing towards the fixing portion, for supporting the tracking tag engaged with the receiving portion.

8. Coupling element according to claim 1, further comprising at least one contact portion engaged with the retaining portion on the opposite side with respect to the fixing and receiving portions of the tracking tag, the contact portion having an abutment surface facing the opposite side with respect to the fixing portion for the engagement of a striker of an application device of the coupling elements.

9. Coupling element according to claim 1, wherein the coupling element is comprised of steel, preferably carbon steel, even more preferably carbon steel subjected to hardening heat treatment.

10. Coupling element according to claim 1, wherein the coupling element has a hardness, expressed in Rockwell scale, between 50 HRC and 58 HRC, preferably between 52 HRC and 56 HRC, even more preferably between 53 HRC and 55 HRC.

11. Coupling element according to claim 1, wherein the coupling element is also subjected to a protective treatment against oxidation, optionally a burnishing surface treatment.

12. System for applying coupling elements of tags for tracking semi-finished metallurgical products, such as billets, slabs, blooms, drums, wire rods, metal beams and/or like, the application system being characterized by the fact to comprise:
at least one coupling element according to claim 1 to be associated with a respective tracking tag and to be applied to a respective target semi-finished metallurgical product;
at least an application device arranged to force the coupling element to penetrate the respective target semi-finished metallurgical product.

13. Application system according to claim 12, wherein the application device comprises:
at least a striker arranged to transmit to the coupling element a thrust force towards the target metallurgical product;
at least an activation mechanism of the striker switchable between a first condition, in which the coupling element is housed in an ejection seat obtained in the striker and a second condition in which it actuates the striker to transmit a thrust force to the coupling element.

14. Application system according to claim 13, wherein the activation mechanism of the application device comprises:
a fluid-dynamic cylinder, preferably a pneumatic cylinder, having one end engaged by the striker;
a collision plunger operatively engaged within the cylinder, the collision plunger being movable along the cylinder to impact against the striker when the activation mechanism is switched from the first to the second condition, the impact between the collision plunger and the striker causing the coupling element thrusting towards the target semi-finished metallurgical product;
at least a fluid-dynamic duct, preferably a pneumatic duct, connected to the cylinder to control the movement of the collision plunger.

15. Application system according to claim 13, wherein the ejection seat of the striker for housing the coupling element to be applied is provided with at least one suction hole, preferably a plurality of suction holes, capable of creating a depression keeping the coupling element in the ejection seat up to the activation by striker.
